(19) United States
(12) Patent Application Publication
(10) Pub. No.: US 2021/0100278 A1
(43) Pub. Date: Apr. 8, 2021

(54) Grinding and Dispensing Assembly

(71) Applicant: Olmes Santofimio Bedoya, Mississauga (CA)

(72) Inventor: Olmes Santofimio Bedoya, Mississauga (CA)

(21) Appl. No.: 16/867,701

(22) Filed: May 6, 2020

Related U.S. Application Data
(60) Provisional application No. 62/911,881, filed on Oct. 7, 2019.

(51) Int. Cl. A24C 5/44; G01F 3/24; B02C 23/10; A24B 7/04; A24D 1/18

(52) U.S. Cl. CPC A24C 5/44; G01F 3/24; A24D 1/18; A24B 7/04; B02C 23/10

(57) ABSTRACT

An assembly for grinding and dispensing a substance. The assembly includes a grinding chamber formed by a grinding lid affixed to a grinding chamber housing having a grind mechanism. A joint mode base is removably secured to a lower side of the grinding chamber housing, wherein the joint mode base can transfer a ground substance from the grinding chamber housing directly into a rolling paper. The joint mode base includes a chamber funnel that can rotate between a loading position and a dispensing position. In the loading position, the chamber funnel receives the ground substance from the grinding chamber housing. In the dispensing position, the chamber funnel is rotated to dispense the ground substance onto a platform having a curved channel that holds the rolling paper. The joint mode base is interchangeable with other bases that can transfer the ground substance into a different receptacle.

### CROSS REFERENCE TO RELATED APPLICATION

This application claims the benefit of pending U.S. Provisional Application No. 62/911,881 filed on Oct. 7, 2019; the above identified patent application is herein incorporated by reference in its entirety.

### BACKGROUND OF THE INVENTION

The present invention relates to a dispensing device. The present invention provides a grinding and dispensing assembly configured to receive a predetermined amount of ground substance and selectively dispense the predetermined amount to a user or other receptacle without the need for hand manipulation.

Many people ingest medication or herbs that requires the particle size of the provided form to be reduced for greater efficacy or ease of use, such as pills in powder form or cannabis ground from its natural plant form. Unfortunately, cross contamination regularly occurs with hand manipulation of these medications and herbs. Point of contact occurs when pills or cannabis are initially removed from its container, when being ground, and transferred to another receptacle, such as rolling papers, or directly consumed. Rolling papers are heavily manipulated during transfer of ground substance due to a user having to maintain a curved configuration of the paper to ensure the substance is kept central on the paper.

Furthermore, there are different means of ingesting the substance once it is ground. The substance can be transferred to a rolling paper, a vaporizer attachment, or other smoking means. However, in addition to cross contamination, some of the substance is likely to be wasted as a result of an imperfect transferring vessel. Therefore, in order to prevent waste and cross contamination through direct handling, there exists a need in the prior art for an assembly configured to grind and dispense a predetermined amount directly from a grinder onto a rolling paper or other receptacle.

In light of the devices disclosed in the known art, it is submitted that the present invention substantially diverges in design elements and methods from the known art and consequently it is clear that there is a need in the art for an improvement for a grinding and dispensing assembly. In this regard the instant invention substantially fulfills these needs.

### SUMMARY OF THE INVENTION

In view of the foregoing disadvantages inherent in the known types of dispensing devices now present in the known art, the present invention provides a dispensing device wherein the same can be utilized for receiving a predetermined amount from a container and selectively distributing the predetermined amount to a user or other receptacle without the need for hand manipulation.

It is an objective of the present invention to provide a grinding and dispensing assembly comprising a grinding chamber configured receive and grind a substance, wherein the grinding chamber is formed by a grinding lid rotatably affixed to a grinding chamber housing, wherein the grinding chamber comprises a grinding mechanism and a plurality of apertures extending through the lower side of the grinding chamber housing.

It is another objective of the present invention to provide a grinding and dispensing assembly wherein the grinding mechanism is a plurality of first protrusions extending through the lower side of the grinding chamber housing and a plurality of second protrusions extending from an interior side of the grinding lid, wherein the substance positioned within the grinding chamber is adapted to be ground by cooperative engagement of the plurality of first protrusions with the plurality of the second protrusions.

It is another objective of the present invention to provide a grinding and dispensing assembly further comprising a joint mode base removably securable to a lower side of the grinding chamber housing, wherein the joint mode base is configured to dispense the ground substance into a rolling paper housed thereon.

It is another objective of the present invention to provide a grinding and dispensing assembly wherein the joint mode base comprises funnel assembly and a platform, wherein the funnel assembly comprises a chamber funnel configured to rotate between a loading position and a dispensing position, such that in the loading position a recess of the chamber funnel receives the ground substance from the grinding chamber housing and in the dispensing position the recess of the chamber funnel is rotated to face the platform to dispense the ground substance.

It is another objective of the present invention to provide a grinding and dispensing assembly wherein the platform comprises a curved channel extending from opposing sides of an upper end thereof, wherein the curved channel is configured to receive the rolling paper and maintain the rolling paper in a curved position.

It is another objective of the present invention to provide a grinding and dispensing assembly wherein the joint mode base is interchangeable with other bases that can transfer the ground substance into a different receptacle.

It is therefore an object of the present invention to provide a new and improved new dispensing device that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the grinding and dispensing assembly.

FIG. 2 shows an exploded view of an embodiment of the grinding and dispensing assembly.

FIG. 3A shows a planar view of a lower surface of the grinding chamber housing of an embodiment of the grinding and dispensing assembly.

FIG. 3B shows a planar view of an upper surface of the grinding lid of an embodiment of the grinding and dispensing assembly.

FIG. 4 shows a cross sectional view of an embodiment of the grinding and dispensing assembly of FIG. 1 taken along line 4-4.

FIG. 5 shows a planar view of a lower side of the upper funnel of an embodiment of the grinding and dispensing assembly.

FIG. 6 shows a perspective view of the chamber funnel of an embodiment of the grinding and dispensing assembly.

FIG. 7A shows a side view of the chamber funnel in the funnel base of an embodiment of the grinding and dispensing assembly, wherein the chamber funnel is in the loading position.

FIG. 7B shows a side view of the chamber funnel in the funnel base of an embodiment of the grinding and dispensing assembly, wherein the chamber funnel is in the dispensing position.

FIG. 8 shows a planar view of a lower side of the funnel base of an embodiment of the grinding and dispensing assembly of FIG. 1 taken along line 8-8.

FIG. 9A shows an exploded view of an embodiment of the grinding and dispensing assembly in use.

FIG. 9B shows a perspective view of an embodiment of the grinding and dispensing assembly in use.

FIG. 9C shows a perspective view of the platform of an embodiment of the grinding and dispensing assembly in use.

FIG. 10 shows an exploded view of the vape mode base and grinding chamber of an embodiment of the grinding and dispensing assembly.

FIG. 11 shows a cross sectional view of the vape funnel and the plug of an embodiment of the grinding and dispensing assembly.

FIG. 12 shows a perspective view of the vape funnel and the plug of an embodiment of the grinding and dispensing assembly in use.

FIG. 13 shows an exploded view of the standard mode base and the grinding chamber of an embodiment of the grinding and dispensing assembly.

FIG. 14 shows a perspective view of the grinding chamber with the joint mode base, the vape mode base, and the standard mode base.

### DETAILED DESCRIPTION OF THE INVENTION

For the purposes of presenting a brief and clear description of the present invention, the preferred embodiment will be discussed as used for receiving, grinding, and dispensing a substance. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment.

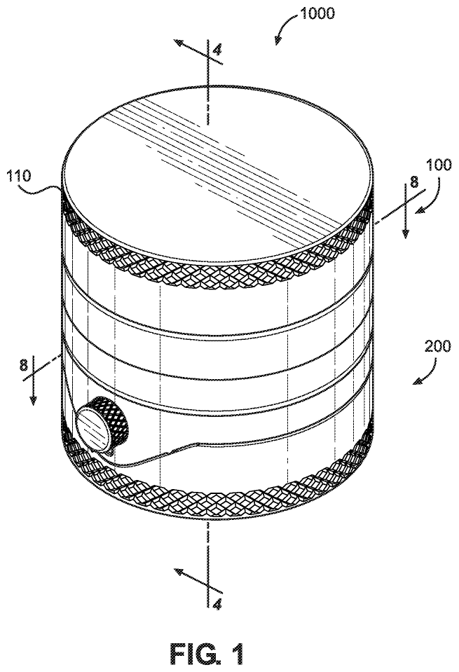

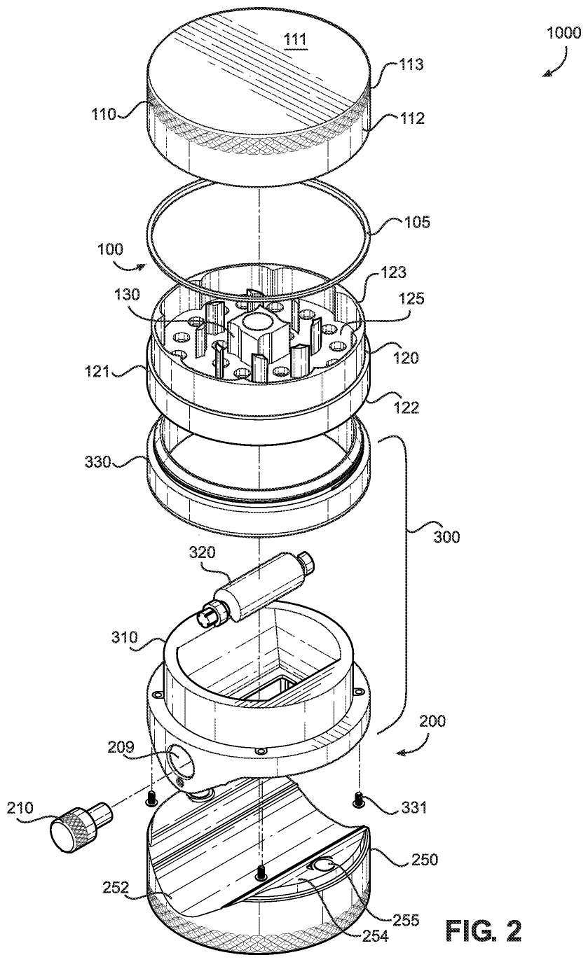

Referring now to FIGS. 1 and 2, there is shown a perspective view and an exploded view of an embodiment of the grinding and dispensing assembly, respectively. The assembly 1000 comprises a grinding chamber 100 configured to receive and grind a substance. The grinding chamber 100 is removably securable to a joint mode base 200, wherein the joint mode base 200 is configured to dispense the ground substance received from the grinding chamber 100 directly into a rolling paper. In the illustrated embodiment, the joint mode base 200 is interchangeable with a vape mode base and a standard mode base to allow a user to dispense the ground substance into an alternate receptacle, such as a vaporizer attachment, without the need to have hand contact with the ground substance.

The grinding chamber 100 is formed by a grinding lid 110 removably affixed to a grinding chamber housing 120. When the grinding lid 110 is separated from the grinding chamber housing 120, the interior of the grinding chamber housing 120 is configured to receive the substance to be ground. In the illustrated embodiment, the grinding chamber 100 is rotatably affixed to the grinding chamber housing 120 and comprises a grinding mechanism configured to grind the substance when the grinding lid 110 is rotated about the grinding chamber housing. In the illustrated embodiment, the grinding chamber 100 comprises a circular cross section to allow for effortless rotation between the grinding lid 110 and the grinding chamber housing 120. In the illustrated embodiment, an upper surface 111 of the grinding lid 110 forms the uppermost surface of the grinding and dispensing assembly 1000, wherein the upper surface 111 is flat. In some embodiments, a grip 113 is disposed around an exterior of the grinding lid 110 to allow a user to grip the grinding lid 110 without slipping while in operation. In the illustrated embodiment, the grip 113 is a textured or knurled surface.

The grinding chamber housing 120 comprises a lower side 122 and an upper side 123, wherein the grinding lid 110 secures to the upper side 123 thereof. In the illustrated embodiment, the grinding lid 110 rests upon a lip 121 formed between the lower and upper sides 122, 123 of the grinding chamber housing 120 in a secured position. The lip 121 enables an exterior side of the grinding chamber 110 to have a continuous, leveled surface, which allows for better gripping by the user when in operation. In other embodiments, the grinding lid 110 is securable to an interior of the upper side of the grinding chamber housing 120. In some embodiments, an O-ring 105 is positioned on the lip 121 to absorb the rotational friction when the grinding chamber is in operation and preserve the structural integrity of the grinding lid 110 and grinding chamber housing 120. In other embodiments, the O-ring forms a hermetical seal.

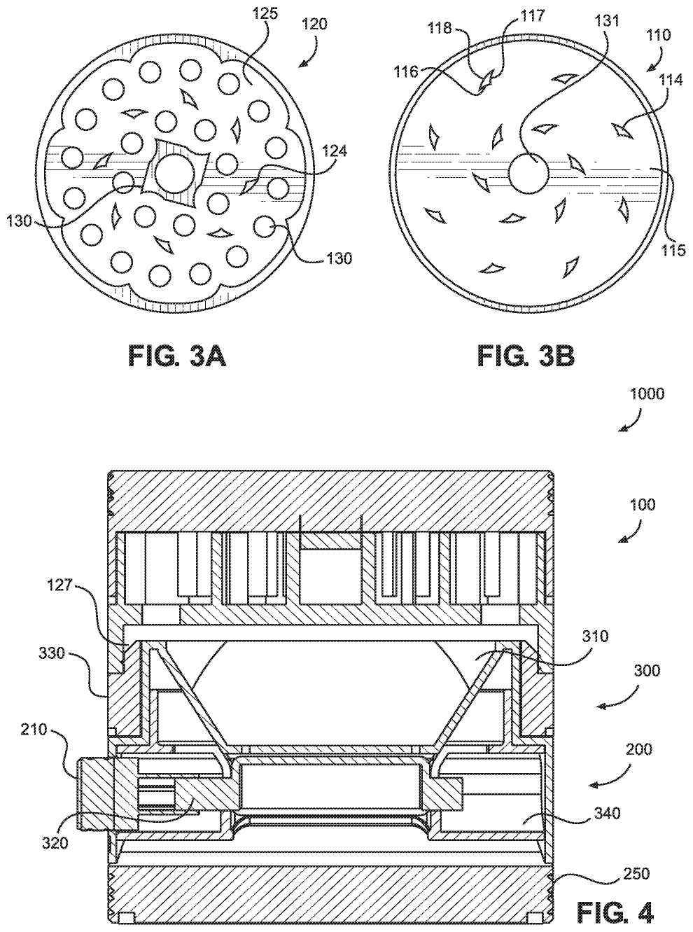

Referring now to FIGS. 2, 3A, and 3B, there is shown exploded view of an embodiment of the grinding and dispensing assembly, a planar view of a lower surface of the grinding chamber housing, and a planar view of an upper surface of the grinding lid, respectively. In the illustrated embodiment, the grinding mechanism of the grinding chamber 100 is formed by a plurality of first protrusions 124 extending from an interior lower side 125 of the grinding chamber housing 120 and a plurality of second protrusions 114 extending from an interior upper side 115 of the grinding chamber lid 110. Each protrusion 114, 124 extends toward an interior of the grinding chamber 100. When the grinding lid 110 is rotated about the grinding chamber housing 120, the substance positioned within the grinding chamber is adapted to be ground into a ground substance by cooperative engagement of the first protrusions 114 with the second protrusions 115.

In the illustrated embodiment, each protrusion extends perpendicular from the respective interior surface. Each protrusion comprises a first concave sidewall 116 adjacent to a second concave sidewall 117 and a convex third sidewall 118. In this way, the edges between each sidewall are sharp and configured for shearing the substance. The sidewalls extend an entire length of the protrusion. In some embodiments, the first protrusions are in a circular formation and the second protrusions form two concentric circular formations, wherein the first protrusions are between the two circular formations of the second protrusions. Each circular formation is defined concentric to the exterior perimeter of the grinding chamber 100. In this way, all of the first protrusions are between all of the second protrusions when the grinding lid 110 is secured to the grinding chamber housing 120, such that as the grinding chamber housing 120 rotates relative to the grinding lid 110 the first protrusions are not obstructed by the second protrusions.

In alternate embodiments, the grinding and dispensing assembly comprises any suitable grinding mechanism configured to received and grind herbs and other medication. In the illustrated embodiment, the operation of the grinding mechanism is manual. However, it is contemplated in other embodiments that the grinding mechanism is mechanically operated upon actuation of a button or lever disposed on the grinding chamber.

The grinding and dispensing assembly further comprises an aperture configured to allow the ground substance to transfer from the interior of the grinding chamber 100 to a base. In the illustrated embodiment, a plurality of apertures 130 are disposed on the lower side 125 of the grinding chamber housing 120 and spaced equidistance from one another. The apertures form two concentric circular formations, wherein the first circular formation is disposed around the circular formation of the first protrusions and the second circular formation of the apertures is interior to the first protrusions. In this way, once the substance is ground it is gravity fed to a base disposed therebeneath. In the illustrated embodiment, the apertures are sized to receive a ground substance, but too small to allow unground substance (such as a whole leaf or pill) to pass therethrough.

The grinding lid 110 is securable to the grinding chamber housing 120 via a connection that permits the grinding lid 110 to remain secured to the grinding chamber housing 120 when rotated thereabout. In the illustrated embodiment, the grinding chamber housing 120 comprises a raised fastener 130 configured to mate with a fastener 131 disposed on the interior upper side of the grinding lid 110. The fasteners 130, 131 are aligned in a stacked position when attached to one another. The raised fastener 130 further comprises sharp edges formed by adjacent curved sidewalls to assist in grinding the substance. The fasteners are magnetic in order to maintain a strong connection while preventing obstruction with other components of the grinding chamber 100 and allowing for quick release and securement.

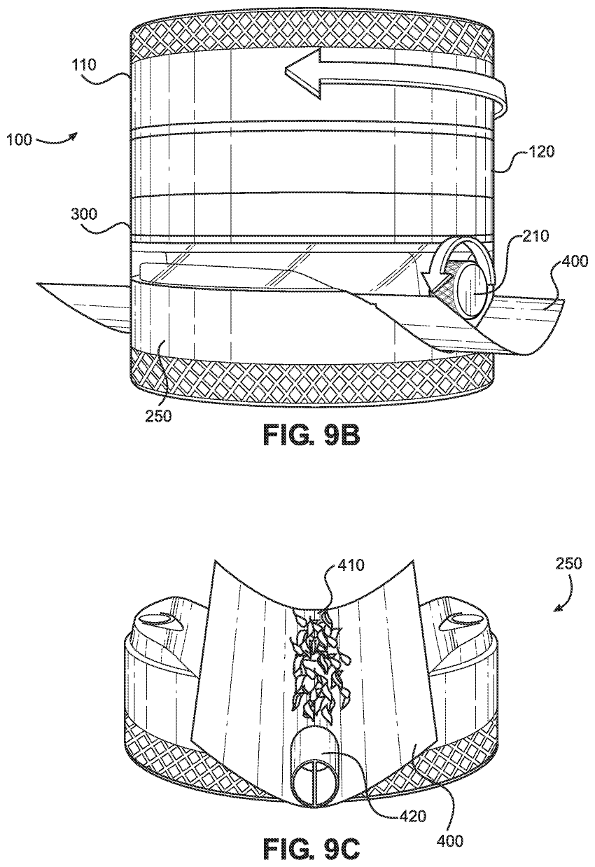

Referring now to FIGS. 2 and 4, in addition to the exploded view, there is shown a cross sectional view of the grinding and dispensing assembly of FIG. 1 taken along line 4-4. The joint mode base 200 is configured to receive the ground substance from the apertures of the grinding chamber 100 and dispense directly into a rolling paper. The joint mode base 200 includes a funnel assembly 300 removably secured to a platform 250. The rolling paper is configured to be received and secured between the funnel assembly 300 and platform 250, as shown in FIG. 9B. In the illustrated embodiment, the funnel assembly 300 comprises an upper funnel 310 that secures to the platform 250 and the grinding chamber housing 120. In some embodiment, the upper funnel 310 comprises a threaded ring 330 secured to an upper side thereof, wherein the threaded ring 330 removably secures to an interior sidewall 127 of the grinding chamber housing 110. In the illustrated embodiment, the upper funnel is secured to the threaded ring 330 via screws 331.

Referring now to FIG. 5, there is shown a planar view of a lower side of the upper funnel of an embodiment of the grinding and dispensing assembly. The upper funnel 310 comprises a same cross-sectional shape (taken along a horizontal plane) as the grinding chamber 100 in order to secure thereto. The upper funnel 310 comprises an upper opening that tapers to a first elongated slot. The ground substance travels through the upper opening and is funneled through the first elongated slot.

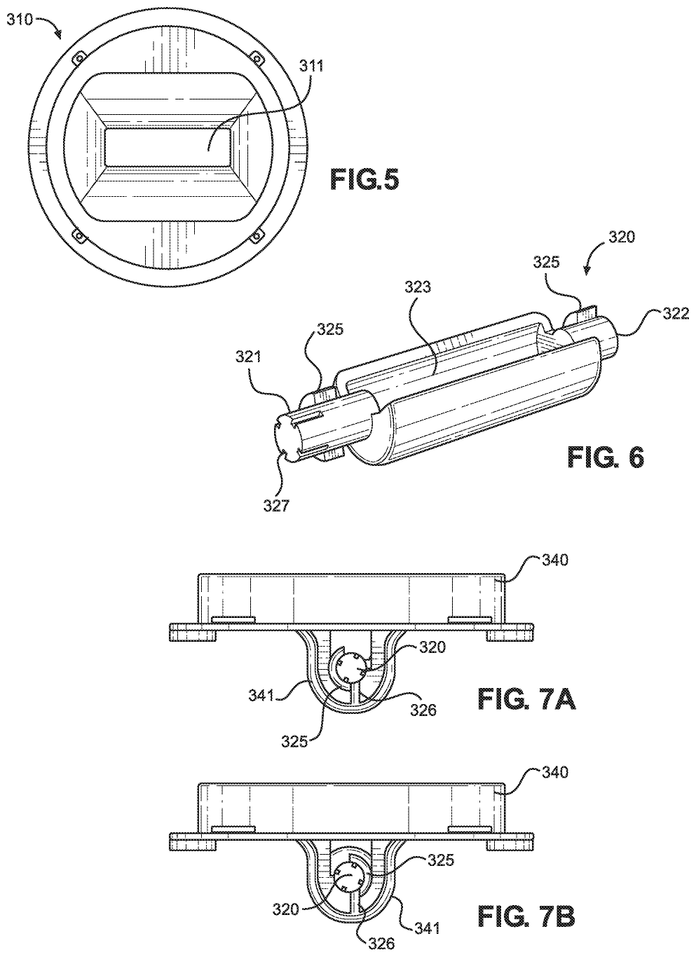

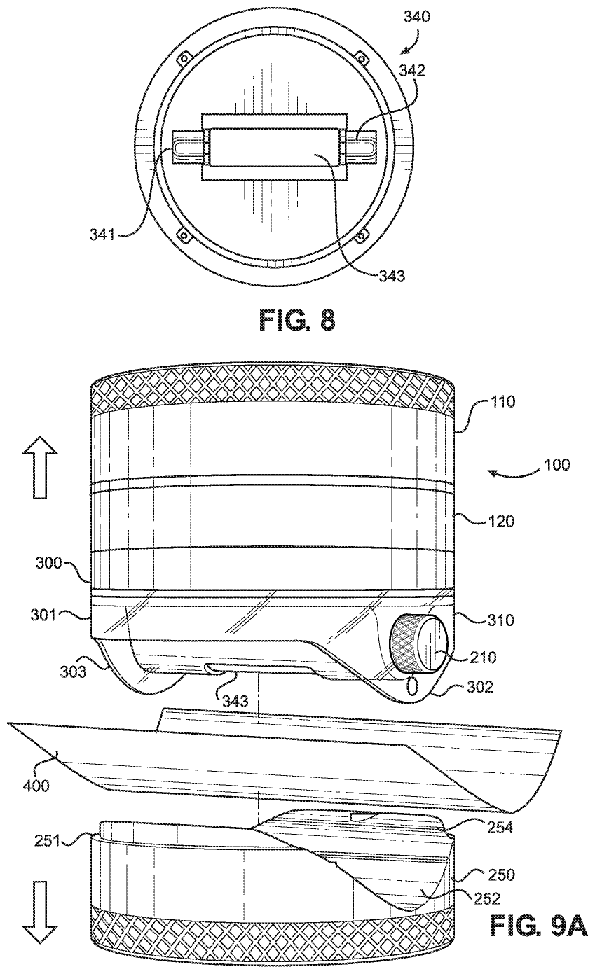

Referring now to FIGS. 6-8, there is shown a perspective view of the chamber funnel, side views of the chamber funnel in the funnel base, and a planar view of a bottom side of the funnel base, respectively. The funnel assembly 300 further comprises a chamber funnel 320 that rotatably sits within a funnel base 340 and beneath the upper funnel 310. The chamber funnel 320 is rotatable between a loading position and a dispensing position. In the illustrated embodiment, the chamber funnel 320 is substantially cylindrical in shape having a pair of tabs 321, 322 extending from opposing ends thereof. The tabs 321, 322 rest within a pair of corresponding U-shaped tab receivers 341 of the funnel base 340. Between the pair of tab receivers 341 of the funnel base 340 is a second elongated slot 343. The second elongated slot 343 is aligned beneath the first elongated slot of the upper funnel. In the illustrated embodiment, the funnel base 340 comprises a circular perimeter corresponding to the perimeter shape of the upper funnel, wherein the funnel base is secured directly to the upper funnel.

The chamber funnel 320 comprises a recess 323 extending between the two tabs 321, 321, wherein the recess 323 is configured to receive the ground substance from the first elongated slot while in the loading position and dispense the ground substance through the second elongated slot while in the dispensing position. The second elongated slot 343 is disposed above the platform in the dispensing position. In some embodiments, the first elongated slot and the second elongated slot have a same width and length. In one embodiment, the first elongated slot is dimensionally smaller than the second elongated slot such that the entire perimeter of the first elongated slot are positioned interior the second elongated slot when viewed from an overhead planar view. In some embodiments, the first elongated slot, second elongated slot, and recess each extend the substantial length of the chamber funnel, wherein the length is substantially equivalent to a length of the rolling paper. In this way, as the ground substance is dispensed from the funnel assembly, a predetermined amount is automatically positioned along the majority of the length of the rolling paper. Therefore, minimizing additional hand manipulation needed to disperse the substance along the length of the rolling paper.

In the illustrated embodiment, a stopper 325 extends circumventially about each of the tabs 321, 322 forming a C-shape flange. In some embodiments, only one tab comprises the stopper. The stopper 325 is configured to define the maximum positions of the loading position and the dispensing position, respectively. In the illustrated embodiment, the channel funnel is configured to rotate 180 degrees in opposing directions, between the loading and the dispensing positions. A projection 326 extends within the tab receivers 341, 342 configured to prevent the stopper from rotating therebeyond.

One of the tabs 321 of the chamber funnel 320 comprises a mounting notch 327 that is secured to a knob (see FIG. 2, 210) to allow rotation thereof. The knob is exterior to the joint mode base and engages with the chamber funnel to allow a user to selectively rotate the chamber funnel between the loading position and the dispensing position. In some embodiments, the knob is biased to the loading position. In this way a user can turn the knob with a single movement to dispense the substance from the funnel chamber.

Referring now to FIGS. 9A-9C, there is shown an exploded view and a perspective view of an embodiment of the grinding and dispensing assembly in use, and a perspective view of the platform in use. In the illustrated embodiment, the upper funnel 310 comprises a sidewall 301 wherein the lower perimeter 303 thereof tapers downwards at opposing ends forming a pair of curved areas 302. One of the curved areas comprises an aperture (see FIG. 2, 209) where the knob extends therethrough. The lower perimeter 303 of the sidewall rests flush on a lip 251 of the platform 250, such that the exterior of the joint mode base 300 is continuously planar.

In the illustrated embodiment, the platform 250 comprises a curved channel 252 extending from opposing sides of an upper end thereof. The curved channel 252 is configured to receive and retain the rolling paper in a curved position. The curved areas 302 of the upper funnel are configured to align with the opposing ends of the curved channel.

The platform 250 comprises a cross sectional shape that corresponds with the overall cross-sectional shape of the funnel assembly and the grinding chamber. In this way, the grinding and dispensing assembly comprises a cylindrical shape that is compact and easy to handle when in operation and being transported between locations.

A pair of opposing ridges 254 extend from the upper surface of the platform 250 and are removably securable to the funnel assembly in order to secure the rolling paper therebetween. In the illustrated embodiment, each ridge 254 comprises magnetic fastener 255 securable to a lower side of the funnel base 340.

In operation of the grinding and dispensing assembly with the joint mode base, a user loads the grinding chamber 100 with a predetermined amount of substance. A rolling paper 400 is placed on the upper surface of the platform 250 and the funnel assembly 300 is secured to both the grinding chamber housing 120 and platform 250. The grinding lid 110 is rotated about the grinding chamber housing 120 until the substance is ground. The ground substance 410 passes through the apertures of the grinding chamber housing 120 and into the funnel assembly 300. The ground substance is funneled through the upper funnel to the first elongated slot. Once the knob 210 is turned such that the chamber funnel is in the loading position, the ground substance passes into the recess of the chamber funnel via gravity. The user then turns the knob 180 degrees thereby rotating the chamber funnel to the dispensing position such that the recess is facing downward above the second elongated slot. The second elongated slot is disposed directly above the rolling paper 400 such that the ground substance 410 passes through the second elongated slot and onto the rolling paper via gravity. The chamber funnel is adapted to rotate to dispense the ground substance without contacting the rolling paper positioned on the platform. In one embodiment, as the ground substance is dispensed onto the rolling paper, there is clearance between the chamber funnel and rolling paper such that actuation of the knob and chamber funnel does not affect the ground substance position on the rolling paper., thereby providing for even dispersal of the ground substance on the rolling paper. The funnel assembly and grinding chamber 100 are separated from the platform, wherein the rolling paper and ground substance remain thereon. A tip 420 can be placed at an end of the rolling paper 400, wherein a user then rolls a joint. In this way, the user is eliminating or reducing potential for cross contamination and the need for a user to grind or dispense the substance by hand.

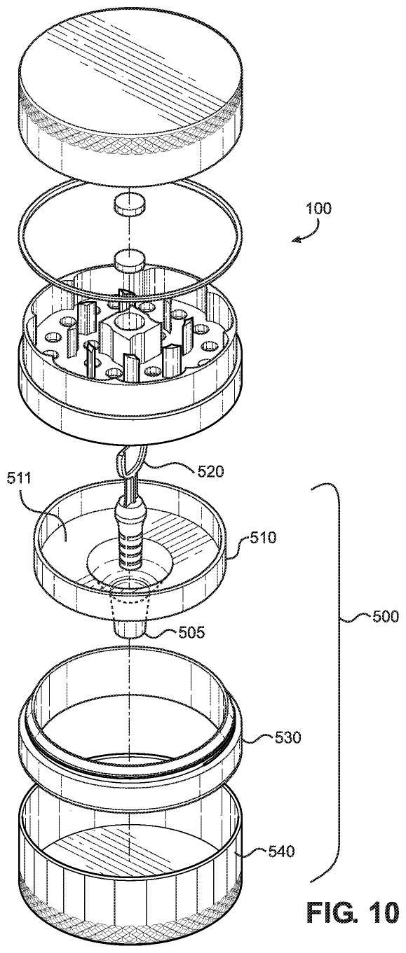

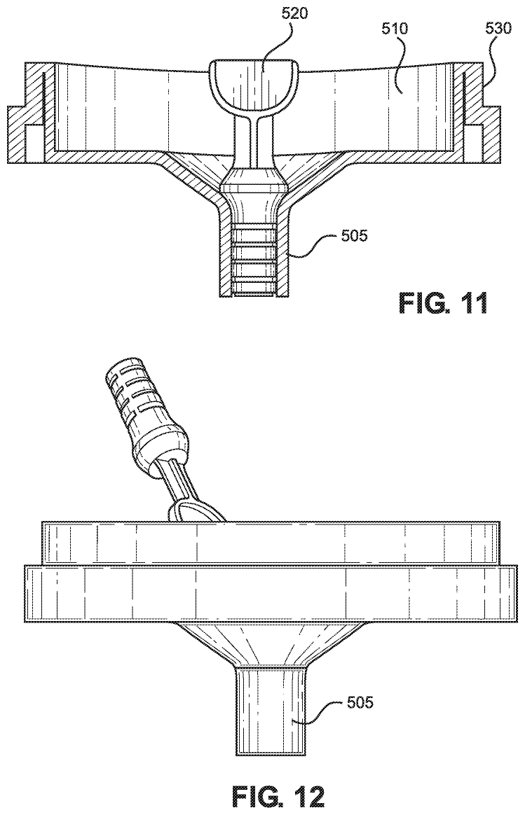

Referring now to FIGS. 10-12, there is shown an exploded view of the vape mode base and grinding chamber of an embodiment of the grinding and dispensing assembly, a cross sectional view of the vape funnel and the plug, and a perspective view of the vape funnel and the plug in use. The joint mode base is interchangeable with other bases configured to transfer the ground substance into a different receptacle. In the illustrated embodiment, the grinding and dispensing assembly further comprises a vape mode base 500. The vape mode base 500 is configured to be used with a vaporizer or a vaporizer attachment. A vape funnel 510 sits within a collar 530, wherein a first side of the collar 531 is configured to removably engage with the lower end of the grinding chamber 100. In some embodiments, the collar 531 frictionally fits to the grinding chamber, wherein alternate embodiments, the collar threadedly engages with the grinding chamber.

The vape funnel 510 comprises a flat lower interior side 511 having a spout 505 extending downward and away from the grinding chamber 100. In the illustrated embodiment, the lower interior side 511, that encircles the spout 505, is planar and parallel to the upper side of the grinding lid when attached to the grinding chamber. The flat interior side 511 is configured to prevent all the ground substance received through the apertures from falling into spout 505 simultaneously. Rather, the user can selectively control how much of the ground substance is moved from the interior side 511 of the vape funnel and passed through the spout 505.

The spout 505 is configured to funnel the ground substance into another receptacle having a narrow opening such as a vaporizer attachment. The upper opening of the spout 505 is disposed centrally on the surface of the lower interior side 511. In other embodiments, the lower interior side of the vape funnel is tapered interior lower side that is positioned beneath all the apertures of the grinding chamber when attached thereto. In this way, the ground substance that passes through the apertures is received by the vape funnel 510 and directed to a spout 505 disposed centrally on the lower side of the vape funnel 510. In some embodiments, the vape mode base 500 comprises an end cap 540 having a base and a sidewall extending therefrom. The end cap 540 is configured to secured to the collar 510 and enclose the vape funnel 510. The spout 505 is configured to extend into the end cap 540.

In the illustrated embodiment, the vape base mode 500 comprises a plug 520 having a first end removably disposed within the spout 505 to prevent flow therethrough and for storing when not in use. An opposing second end of the plug 520 comprises a scraper configured to assist a user in directing the ground substance on the lower side 511 of the vape funnel 510 and into the spout 505. In this way, the user does not have to use his or her hands, thereby preventing any cross-contamination. In some embodiments, the first end of the plug comprises ridges in order to allow easier gripping thereof.

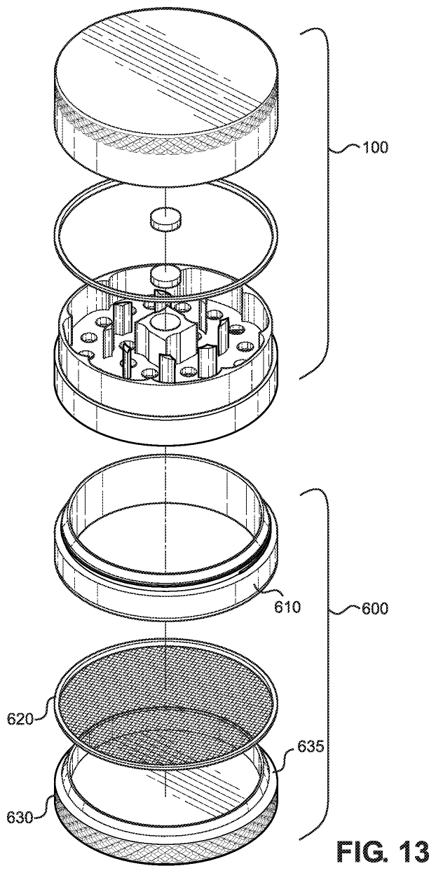

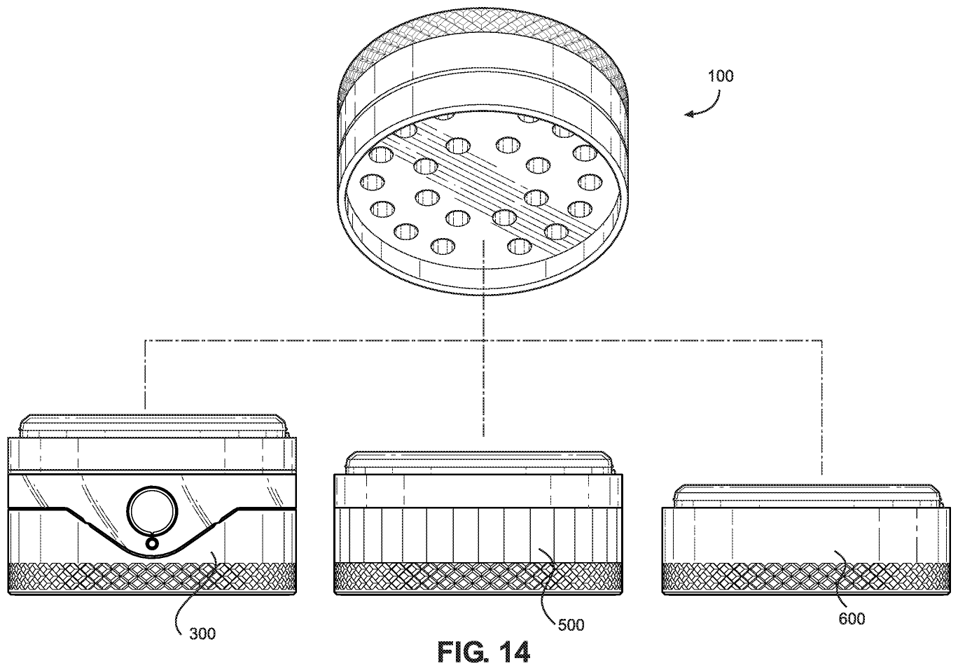

Referring now to FIGS. 13 and 14, there is shown an exploded view of the standard mode base and a perspective view of the grinding chamber with the joint mode base, the vape mode base, and the standard mode base. In some embodiments, the joint mode base 300 and/or the vape mode base 500 are each interchangeable with a standard base mode 600. The standard base mode 600 comprises a holding chamber formed by a collar 610 and mesh screen 620. The collar is removably securable to a lower end of the grinding chamber 100 and configured to receive ground substance from the grinding chamber 100. In some embodiments, the collar is threadedly engageable with the grinding chamber 100 and in alternate embodiments the engagement is via a friction fit.

The mesh screen 620 is disposed above a pollen chamber 630, wherein the mesh screen 620 is configured to filter small particles of the ground substance into the pollen chamber 630. The pollen chamber 630 comprises a base and a sidewall securable to a lower end of the collar 610. The sidewall comprises a lip 635 configured to engage with the lower end of the collar 610 via a friction fit.

In some embodiments, each base comprises a grip disposed on a lower end thereof, such as a knurled or textured surface. In other embodiments, a non-slip O-ring or layer is disposed on the lower most surface to prevent the assembly from slipping on a surface, such as a table, while in operation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A grinding and dispensing assembly, comprising:
a grinding chamber configured to receive and grind a substance, wherein the grinding chamber is formed by a grinding lid rotatably affixed to a grinding chamber housing, wherein the grinding chamber comprises:
a grinding mechanism adapted to grind the substance when selectively actuated
a plurality of apertures extending through a lower side of the grinding chamber housing;
the grinding lid removably secured to an upper side of the grinding chamber housing;
a joint mode base removably secured to a lower side of the grinding chamber housing, wherein the joint mode base is configured to dispense the ground substance into a rolling paper;
wherein the joint mode base includes a funnel assembly removably secured to a platform;
wherein the funnel assembly comprises:
an upper funnel configured to transfer the ground substance into a chamber funnel;
wherein the chamber funnel rotatably sits in a funnel base,
wherein the platform comprises a curved channel extending from opposing sides of an upper end thereof, wherein the curved channel is configured to retain the rolling paper in a curved position;
wherein the chamber funnel is adapted to rotate between a loading position and a dispensing position, such that in the loading position a recess of the chamber funnel faces the upper funnel to receive the ground substance from the grinding chamber housing and in the dispensing position the recess of the chamber funnel faces the platform to dispense the ground substance.

2. The grinding and dispensing assembly of claim 1, wherein the joint mode base is interchangeable with a vape mode base, wherein the vape mode base comprises:
a collar having a first side configured to removably engage with a lower end of the grinding chamber;
a vape funnel having a spout extending away from the grinding chamber, configured to funnel the ground substance therethrough, wherein the vape funnel is seated within the collar;
a plug having a first end removably disposed within the spout preventing flow therethrough and a scraper on a second end.

3. The grinding and dispensing assembly of claim 2, wherein an interior side of the vape funnel that encircles the spout is planar and parallel to an upper surface of the grinding lid when the vape mode base is secured to the grinding chamber.

4. The grinding and dispensing assembly of claim 2, further comprising an end cap having a base and a sidewall extending therefrom, wherein the sidewall is configured to secure to a second side of the collar and form a lowermost end of the vape mode base.

5. The grinding and dispensing assembly of claim 1, wherein the grinding mechanism comprises a plurality of first protrusions extend from a lower interior side of the grinding chamber housing and a plurality of second protrusions extend from the an interior upper side of the grinding lid, wherein the substance positioned within the grinding chamber is adapted to be ground into a ground substance by cooperative engagement of the plurality of first protrusions with the plurality of the second protrusions as the grinding lid is rotated about the grinding chamber housing when attached thereto.

6. The grinding and dispensing assembly of claim 5, wherein the plurality of the first protrusions and the second protrusions each comprise a first concave sidewall adjacent to a second concave sidewall and a convex third sidewall.

7. The grinding and dispensing assembly of claim 5, wherein all of the first protrusions are between all of the second protrusions when the grinding lid is secured to the grinding chamber, such that as the grinding chamber rotates relative to the grinding lid the plurality of the first protrusions are not obstructed by the plurality of the second protrusions.

8. The grinding and dispensing assembly of claim 1, further comprising a fastener disposed centrally on an upper most horizontal plane of the recess configured to removably secure to mating fastener on a roof of the grinding lid.

9. The grinding and dispensing assembly of claim 1, wherein a lower end of the grinding chamber is threadedly secured to the joint mode base.

10. The grinding and dispensing assembly of claim 1, wherein the upper funnel comprises sidewall wherein a lower perimeter of the sidewall tapers downwards at opposing ends forming a pair of curved areas that are parallel to one another and configured to align with opposing ends of the curved channel.

11. The grinding and dispensing assembly of claim 10, wherein one of the curved sidewalls comprises an aperture having a knob extending therethrough, the knob engaged with the chamber funnel to allow a user to selectively rotate the chamber funnel between the loading position and the dispensing position.

12. The grinding and dispensing assembly of claim 11, wherein an end of the chamber funnel comprises a mounting notch secures to the knob to allow simultaneous rotation.

13. The grinding and dispensing assembly of claim 1, wherein the platform comprises a pair of ridges magnetically securable to a lower side of the funnel base.

14. The grinding and dispensing assembly of claim 1, wherein the upper funnel comprises a first elongated slot having a same width and length as the recess of the chamber funnel, wherein the first elongated slot aligns directly above the recess to allow the ground substance to pass therethrough in the loading position.

15. The grinding and dispensing assembly of claim 14, wherein the funnel base comprises a second elongated slot, wherein the second elongated slot aligns directly beneath the recess to allow the ground substance to pass therethrough in the dispensing position.

16. The grinding and dispensing assembly of claim 1, wherein the chamber funnel comprises a tab extending from an end thereof, wherein a stopper extends circumventially about the tab forming a C-shape flange such that the stopper defines the maximum positions of the loading position and the dispensing position respectively.

17. The grinding and dispensing assembly of claim 1, wherein the joint mode base is interchangeable with a standard mode base, the standard mode base comprising:
a holding chamber secured to a lower end of the grinding chamber and configured to receive ground substance therefrom,
a mesh screen engaged with a lower end of the holding chamber and configured to filter small particles of the ground substance to a pollen chamber, wherein the pollen chamber comprises a base and a sidewall securable to a lower end of the holding chamber.

18. The grinding and dispensing assembly of claim 1, wherein the joint mode base is interchangeable with a vape mode base and a standard mode base.

19. The grinding and dispensing assembly of claim 1, wherein an upper end of the grinding lid comprises a grip.

20. The grinding and dispensing assembly of claim 1, wherein the funnel assembly is configured to rest flush within the curved channel.
